(19) United States
(12) Patent Application Publication
(10) Pub. No.: US 2026/0269606 A1
(43) Pub. Date: Sep. 10, 2026

(54) POWER SUPPLY SYSTEM

(71) Applicant: HONDA MOTOR CO., LTD., Tokyo (JP)

(72) Inventor: Kenta Shuto, Wako-shi (JP)

(21) Appl. No.: 19/557,974

(22) Filed: Mar. 5, 2026

(30) Foreign Application Priority Data
Mar. 10, 2025 (JP) 2025-037118

(51) Int. Cl. H02J 1/08; B64C 29/00; B64D 27/34; B64D 27/35; H02J 1/082; H02J 4/10

(52) U.S. Cl. CPC H02J 1/084; B64C 29/0025; B64D 27/34; B64D 27/35; H02J 1/082; H02J 4/10; B64D 2221/00

(57) ABSTRACT

A power supply system includes: a first power supply circuit; a first power storage device; a second power storage device having a rated output voltage lower than the rated output voltage of the first power storage device; a first voltage conversion device capable of stepping down direct current electric power supplied from a first power generation device and supplying the stepped down direct current electric power to a second load device and the second power storage device, and capable of boosting direct current electric power supplied from the second power storage device and supplying the boosted direct current electric power to the first power supply circuit; and a first disconnection device capable of disconnecting the second load device from the first voltage conversion device and the second power storage device.

### CROSS-REFERENCE TO RELATED APPLICATIONS

This application is based upon and claims the benefit of priority from Japanese Patent Application No. 2025-037118 filed on Mar. 10, 2025, the contents of which are incorporated herein by reference.

### BACKGROUND OF THE INVENTION

### FIELD OF THE INVENTION

The present disclosure relates to a power supply system.

### DESCRIPTION OF THE RELATED ART

JP 2007-060796 A discloses a power (electric power) buffer device system. For example, a power storage device has a power buffer function. In the case where surplus electric power is generated in a power supply system, the power storage device can temporarily store the surplus electric power. In the case where the electric power demand in the power supply system increases, the power storage device can discharge a shortage of electric power.

### SUMMARY OF THE INVENTION

There has been a demand for a suitable power supply system.

The present disclosure has the object of solving the above-described problem.

An aspect of the present disclosure is characterized by a power supply system comprising: a first power supply circuit configured to supply, to a first load device, direct current electric power output from a first power generation device; a first power storage device connected to the first power supply circuit in parallel with the first power generation device; a second power storage device connected to the first power supply circuit in parallel with the first power generation device, the second power storage device having a rated output voltage lower than a rated output voltage of the first power storage device; a first voltage conversion device configured to step down direct current electric power supplied from the first power generation device and supply the stepped down direct current electric power to a second load device and the second power storage device, and configured to boost direct current electric power supplied from the second power storage device and supply the boosted direct current electric power to the first power supply circuit; and a first disconnection device configured to disconnect the second load device from the first voltage conversion device and the second power storage device.

According to the present disclosure, a suitable power supply system can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of a moving object;

FIG. 2 is a schematic diagram of a power supply system according to an embodiment;

FIG. 3 is a control block diagram of a control device according to the embodiment;

FIG. 4 is a diagram showing the operation of the power supply system according to the embodiment in a normal state;

FIG. 5 is a diagram showing the operation of the power supply system according to the embodiment in the event of an abnormality;

FIG. 6 is a schematic diagram of the power supply system according to a modification; and

FIG. 7 is a diagram showing the operation of the power supply system according to the modification at the time of restarting a generator.

### DETAILED DESCRIPTION OF THE INVENTION

A generator generates electric power by receiving motive power of an engine. For example, a gas turbine engine has a low response. Therefore, in a power generation device including a gas turbine engine, electric power generated by the generator may be excessive or insufficient with respect to electric power required by a load device. Accordingly, a power supply system in which a power generation device is used is provided with a power buffer function of a power storage device. However, when the power storage device becomes unusable, the power buffer function of the power supply system is lost. The present disclosure described below enables a low-voltage power storage device to replace a high-voltage power storage device that has a power buffer function of a power supply system in the case where the high-voltage power storage device becomes unusable.

### 1. Configuration of Moving Object

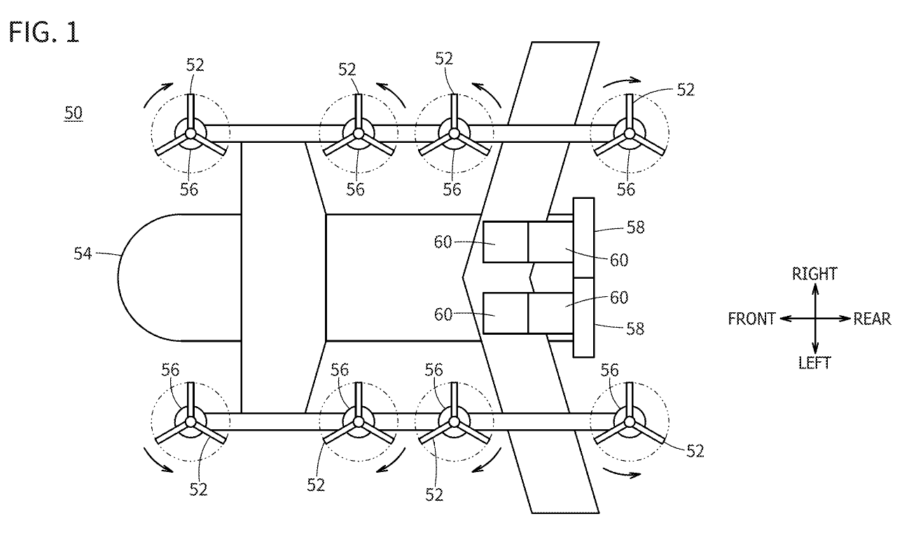

FIG. 1 is a schematic diagram of a moving object 50. A power supply system 10 described below is mounted on the moving object 50. The moving object 50 is, for example, an electric vertical take-off and landing aircraft (eVTOL aircraft). It should be noted that the moving object 50 is not limited to an aircraft, and may be a ship, an automobile, a train, or the like.

The moving object 50 includes eight VTOL rotors 52. The VTOL rotors 52 generate upward thrust for a fuselage 54. The moving object 50 includes eight electric motors 56. One electric motor 56 drives one VTOL rotor 52. The moving object 50 includes two cruise rotors 58. The cruise rotors 58 generate forward thrust for the fuselage 54. The moving object 50 includes four electric motors 60. Two electric motors 60 drive one cruise rotor 58.

### 2. Embodiment

### 2-1. Configuration of Power Supply System 10

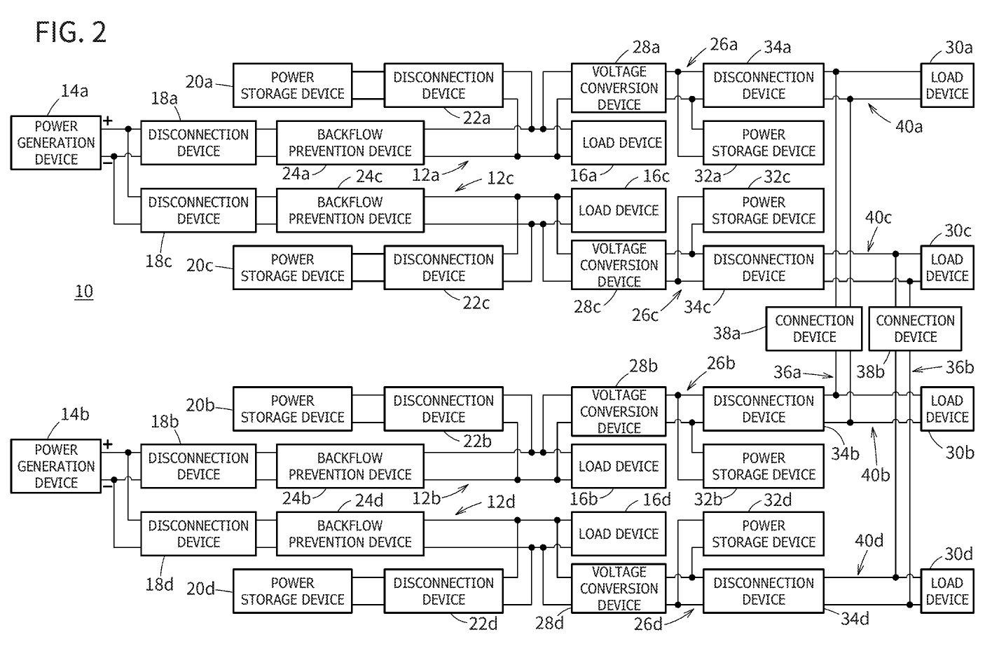

FIG. 2 is a schematic diagram of the power supply system 10 according to an embodiment. The power supply system 10 includes a power supply circuit (first power supply circuit) 12a, a power supply circuit (second power supply circuit) 12b, a power supply circuit (third power supply circuit) 12c, and a power supply circuit (fourth power supply circuit) 12d. The power supply circuit 12a supplies, to a load device (first load device) 16a, DC power output from a power generation device (first power generation device) 14a. The power supply circuit 12b supplies, to a load device (third load device) 16b, DC power output from a power generation device (second power generation device) 14b. The power supply circuit 12c supplies, to a load device (fifth load device) 16c, the DC power output from the power generation device 14a. The power supply circuit 12d supplies, to a load device (seventh load device) 16d, the DC power output from the power generation device 14b.

### Power Generation Devices 14a and 14b

The power supply system 10 includes the power generation device 14a and the power generation device 14b. The power generation device 14a and the power generation device 14b each include an engine (a gas turbine engine, a reciprocating engine, or the like), a generator, and a power control unit (all of which are not shown). The engine drives the generator, and the generator generates three-phase AC power. The power control unit converts the three-phase AC power into DC power. The power generation device 14a and the power generation device 14b each include a capacitor. In the case where the power generation device 14a and the power generation device 14b are started, the capacitor is charged in advance.

The power generation device 14a and the power generation device 14b may each include various sensors such as a voltage sensor and a current sensor, and elements such as a fuse, a relay, a breaker, a diode, a transistor, a resistor, a coil, and a capacitor.

### Load Devices 16a to 16d

The power supply system 10 includes the load device 16a, the load device 16b, the load device 16c, and the load device 16d. The load device 16a, the load device 16b, the load device 16c, and the load device 16d each include an inverter (not shown) and the electric motors 56 and 60 shown in FIG. 1. The inverter converts input DC power into three-phase AC power. The electric motors 56 and 60 are driven by the three-phase AC power. The rated output voltages of the load device 16a, the load device 16b, the load device 16c, and the load device 16d are high voltages of several hundred volts. The load device 16a, the load device 16b, the load device 16c, and the load device 16d are main devices.

The load device 16a, the load device 16b, the load device 16c, and the load device 16d may each include various sensors such as a voltage sensor and a current sensor, and elements such as a fuse, a relay, a breaker, a diode, a transistor, a resistor, a coil, and a capacitor.

### Disconnection Devices 18a to 18d

The power supply system 10 includes a disconnection device 18a, a disconnection device 18b, a disconnection device 18c, and a disconnection device 18d. The disconnection device 18a can disconnect the power generation device 14a from the power supply circuit 12a. The disconnection device 18b can disconnect the power generation device 14b from the power supply circuit 12b. The disconnection device 18c can disconnect the power generation device 14a from the power supply circuit 12c. The disconnection device 18d can disconnect the power generation device 14b from the power supply circuit 12d.

The disconnection device 18a, the disconnection device 18b, the disconnection device 18c, and the disconnection device 18d each include a positive switch and a negative switch. The switches may each be formed of a relay or a contactor. The disconnection device 18a, the disconnection device 18b, the disconnection device 18c, and the disconnection device 18d may each include a breaker.

### Power Storage Devices 20a to 20d

The power supply system 10 includes a power storage device (first power storage device) 20a, a power storage device (third power storage device) 20b, a power storage device (fifth power storage device) 20c, and a power storage device (seventh power storage device) 20d. The power storage device 20a is connected to the power supply circuit 12a in parallel with the power generation device 14a. The power storage device 20b is connected to the power supply circuit 12b in parallel with the power generation device 14b. The power storage device 20c is connected to the power supply circuit 12c in parallel with the power generation device 14a. The power storage device 20d is connected to the power supply circuit 12d in parallel with the power generation device 14b.

The power storage device 20a, the power storage device 20b, the power storage device 20c, and the power storage device 20d each include a lithium ion battery. The power storage device 20a, the power storage device 20b, the power storage device 20c, and the power storage device 20d may each include a secondary battery other than the lithium ion battery. The power storage device 20a, the power storage device 20b, the power storage device 20c, and the power storage device 20d may each include a large-capacity capacitor. The rated output voltages of the power storage device 20a, the power storage device 20b, the power storage device 20c, and the power storage device 20d are high voltages of several hundred volts.

The power storage device 20a, the power storage device 20b, the power storage device 20c, and the power storage device 20d may each include various sensors such as a voltage sensor and a current sensor. The power storage device 20a, the power storage device 20b, the power storage device 20c, and the power storage device 20d may each include elements such as a fuse, a relay, a breaker, a diode, a transistor, a resistor, a coil, and a capacitor.

### Disconnection Devices 22a to 22d

The power supply system 10 includes a disconnection device 22a, a disconnection device 22b, a disconnection device 22c, and a disconnection device 22d. The disconnection device 22a can disconnect the power storage device 20a from the power supply circuit 12a and the load device 16a. The disconnection device 22b can disconnect the power storage device 20b from the power supply circuit 12b and the load device 16b. The disconnection device 22c can disconnect the power storage device 20c from the power supply circuit 12c and the load device 16c. The disconnection device 22d can disconnect the power storage device 20d from the power supply circuit 12d and the load device 16d.

The disconnection device 22a, the disconnection device 22b, the disconnection device 22c, and the disconnection device 22d each include a positive switch and a negative switch. The switches may each be formed of a relay or a contactor. The disconnection device 22a, the disconnection device 22b, the disconnection device 22c, and the disconnection device 22d may each include a breaker.

### Backflow Prevention Devices 24a to 24d

The power supply system 10 includes a backflow prevention device 24a, a backflow prevention device 24b, a backflow prevention device 24c, and a backflow prevention device 24d. The backflow prevention device 24a is provided in the power supply circuit 12a. The backflow prevention device 24a restricts the supply of electric power from the load device 16a and the power storage device 20a to the power generation device 14a. The backflow prevention device 24b is provided in the power supply circuit 12b. The backflow prevention device 24b restricts the supply of electric power from the load device 16b and the power storage device 20b to the power generation device 14b. The backflow prevention device 24c is provided in the power supply circuit 12c. The backflow prevention device 24c restricts the supply of electric power from the load device 16c and the power storage device 20c to the power generation device 14a. The backflow prevention device 24d is provided in the power supply circuit 12d. The backflow prevention device 24d restricts the supply of electric power from the load device 16d and the power storage device 20d to the power generation device 14b.

The backflow prevention device 24a includes a diode and a transistor. The diode and the transistor are provided on the positive wire (or the negative wire). The transistor is provided to bypass the diode. The diode can cause a current to flow from the power generation device 14a to the load device 16a and the power storage device 20a. The transistor can cause a current to flow from the load device 16a and the power storage device 20a to the power generation device 14a by being supplied with an ON signal from a control device 42. The configurations of the backflow prevention device 24b, the backflow prevention device 24c, and the backflow prevention device 24d are the same as the configuration of the backflow prevention device 24a.

The power supply system 10 includes a low-voltage circuit 26a, a low-voltage circuit 26b, a low-voltage circuit 26c, and a low-voltage circuit 26d. The low-voltage circuit 26a supplies, to a load device (second load device) 30a, DC power stepped down by a voltage conversion device (first voltage conversion device) 28a. The low-voltage circuit 26b supplies, to a load device (fourth load device) 30b, DC power stepped down by a voltage conversion device (second voltage conversion device) 28b. The low-voltage circuit 26c supplies, to a load device (sixth load device) 30c, DC power stepped down by a voltage conversion device (third voltage conversion device) 28c. The low-voltage circuit 26d supplies, to a load device (eighth load device) 30d, DC power stepped down by a voltage conversion device (fourth voltage conversion device) 28d.

The low-voltage circuit 26a is connected, via the voltage conversion device 28a, to a partial circuit between the backflow prevention device 24a and the load device 16a in the power supply circuit 12a. The low-voltage circuit 26b is connected, via the voltage conversion device 28b, to a partial circuit between the backflow prevention device 24b and the load device 16b in the power supply circuit 12b. The low-voltage circuit 26c is connected, via the voltage conversion device 28c, to a partial circuit between the backflow prevention device 24c and the load device 16c in the power supply circuit 12c. The low-voltage circuit 26d is connected, via the voltage conversion device 28d, to a partial circuit between the backflow prevention device 24d and the load device 16d in the power supply circuit 12d.

### Voltage Conversion Devices 28a to 28d

The power supply system 10 includes the voltage conversion device 28a, the voltage conversion device 28b, the voltage conversion device 28c, and the voltage conversion device 28d. The voltage conversion device 28a is interposed between the power supply circuit 12a and the low-voltage circuit 26a. The voltage conversion device 28b is interposed between the power supply circuit 12b and the low-voltage circuit 26b. The voltage conversion device 28c is interposed between the power supply circuit 12c and the low-voltage circuit 26c. The voltage conversion device 28d is interposed between the power supply circuit 12d and the low-voltage circuit 26d.

The voltage conversion device 28a, the voltage conversion device 28b, the voltage conversion device 28c, and the voltage conversion device 28d can step down DC power supplied thereto from the primary side (high-voltage side) and supply the stepped down DC power to the secondary side (low-voltage side). Further, the voltage conversion device 28a, the voltage conversion device 28b, the voltage conversion device 28c, and the voltage conversion device 28d can boost DC power supplied thereto from the secondary side (low-voltage side) and supply the boosted DC power to the primary side (high-voltage side).

The voltage conversion device 28a, the voltage conversion device 28b, the voltage conversion device 28c, and the voltage conversion device 28d each include, for example, a DC/DC converter having a variable transformation ratio. Examples of the DC/DC converter include an isolated bidirectional DC/DC converter such as a dual active bridge (DAB) converter. The transformation ratios of the voltage conversion device 28a, the voltage conversion device 28b, the voltage conversion device 28c, and the voltage conversion device 28d are controlled by the control device 42.

### Load Devices 30a to 30d

The power supply system 10 includes the load device 30a, the load device 30b, the load device 30c, and the load device 30d. The load device 30a is connected to the power supply circuit 12a in parallel with the load device 16a. The load device 30a is connected to the power supply circuit 12a via the voltage conversion device 28a. The load device 30b is connected to the power supply circuit 12b in parallel with the load device 16b. The load device 30b is connected to the power supply circuit 12b via the voltage conversion device 28b. The load device 30c is connected to the power supply circuit 12c in parallel with the load device 16c. The load device 30c is connected to the power supply circuit 12c via the voltage conversion device 28c. The load device 30d is connected to the power supply circuit 12d in parallel with the load device 16d. The load device 30d is connected to the power supply circuit 12d via the voltage conversion device 28d.

The load device 30a, the load device 30b, the load device 30c, and the load device 30d each include a low-voltage drive device (an air conditioner, avionics equipment, or the like). The rated output voltages of the load device 30a, the load device 30b, the load device 30c, and the load device 30d are low voltages of several tens of volts. The load device 30a, the load device 30b, the load device 30c, and the load device 30d are auxiliary devices.

### Power Storage Devices 32a to 32d

The power supply system 10 includes a power storage device (second power storage device) 32a, a power storage device (fourth power storage device) 32b, a power storage device (sixth power storage device) 32c, and a power storage device (eighth power storage device) 32d. The power storage device 32a is connected to the power supply circuit 12a in parallel with the power storage device 20a. The power storage device 32a is connected to the power supply circuit 12a via the voltage conversion device 28a. The power storage device 32b is connected to the power supply circuit 12b in parallel with the power storage device 20b. The power storage device 32b is connected to the power supply circuit 12b via the voltage conversion device 28b. The power storage device 32c is connected to the power supply circuit 12c in parallel with the power storage device 20c. The power storage device 32c is connected to the power supply circuit 12c via the voltage conversion device 28c. The power storage device 32d is connected to the power supply circuit 12d in parallel with the power storage device 20d. The power storage device 32d is connected to the power supply circuit 12d via the voltage conversion device 28d.

The power storage device 32a, the power storage device 32b, the power storage device 32c, and the power storage device 32d each include a lithium ion battery. The power storage device 32a, the power storage device 32b, the power storage device 32c, and the power storage device 32d may each include a secondary battery other than the lithium ion battery. The power storage device 32a, the power storage device 32b, the power storage device 32c, and the power storage device 32d may each include a large-capacity capacitor. The rated output voltages of the power storage device 32a, the power storage device 32b, the power storage device 32c, and the power storage device 32d are low voltages of several tens of volts.

### Disconnection Devices 34a to 34d

The power supply system 10 includes a disconnection device (first disconnection device) 34a, a disconnection device (second disconnection device) 34b, a disconnection device (third disconnection device) 34c, and a disconnection device (fourth disconnection device) 34d. The disconnection device 34a is provided in the low-voltage circuit 26a. The disconnection device 34a can disconnect the load device 30a from the voltage conversion device 28a and the power storage device 32a. The disconnection device 34b is provided in the low-voltage circuit 26b. The disconnection device 34b can disconnect the load device 30b from the voltage conversion device 28b and the power storage device 32b. The disconnection device 34c is provided in the low-voltage circuit 26c. The disconnection device 34c can disconnect the load device 30c from the voltage conversion device 28c and the power storage device 32c. The disconnection device 34d is provided in the low-voltage circuit 26d. The disconnection device 34d can disconnect the load device 30d from the voltage conversion device 28d and the power storage device 32d.

The disconnection device 34a, the disconnection device 34b, the disconnection device 34c, and the disconnection device 34d each include a positive switch and a negative switch. The switches may each be formed of a relay or a contactor. The disconnection device 34a, the disconnection device 34b, the disconnection device 34c, and the disconnection device 34d may each include a breaker.

### Connection Circuits 36a and 36b

The power supply system 10 includes a connection circuit (first connection circuit) 36a and a connection circuit (second connection circuit) 36b. The connection circuit 36a is provided with a connection device (first connection device) 38a capable of connecting the low-voltage circuit 26a and the low-voltage circuit 26b. Specifically, the connection circuit 36a can connect a partial circuit 40a between the disconnection device 34a and the load device 30a, and a partial circuit 40b between the disconnection device 34b and the load device 30b. The connection circuit 36b is provided with a connection device (second connection device) 38b capable of connecting the low-voltage circuit 26c and the low-voltage circuit 26d. Specifically, the connection circuit 36b can connect a partial circuit 40c between the disconnection device 34c and the load device 30c, and a partial circuit 40d between the disconnection device 34d and the load device 30d.

The connection device 38a is a switching device capable of connecting and disconnecting the partial circuit 40a and the partial circuit 40b to and from each other. The connection device 38b is a switching device capable of connecting and disconnecting the partial circuit 40c and the partial circuit 40d to and from each other.

The connection device 38a and the connection device 38b each include a contactor. The connection device 38a and the connection device 38b may each include a relay. The connection device 38a and the connection device 38b may each include a breaker. The connection device 38a and the connection device 38b may each include a semiconductor switch.

Normally, the connection between the partial circuit 40a and the partial circuit 40b is cut off. On the other hand, in the case where the disconnection device 34a disconnects the load device 30a from the voltage conversion device 28a and the power storage device 32a, the partial circuit 40a and the partial circuit 40b are connected by the connection device 38a. As a result, electric power is supplied from the power generation device 14b or the power storage device 32b to the load device 30a. Similarly, in the case where the disconnection device 34b disconnects the load device 30b from the voltage conversion device 28b and the power storage device 32b, the partial circuit 40a and the partial circuit 40b are connected by the connection device 38a. As a result, electric power is supplied from the power generation device 14a or the power storage device 32a to the load device 30b.

Normally, the connection between the partial circuit 40c and the partial circuit 40d is cut off. On the other hand, in the case where the disconnection device 34c disconnects the load device 30c from the voltage conversion device 28c and the power storage device 32c, the partial circuit 40c and the partial circuit 40d are connected by the connection device 38b. As a result, electric power is supplied from the power generation device 14b or the power storage device 32d to the load device 30c. Similarly, in the case where the disconnection device 34d disconnects the load device 30d from the voltage conversion device 28d and the power storage device 32d, the partial circuit 40c and the partial circuit 40d are connected by the connection device 38b. As a result, electric power is supplied from the power generation device 14a or the power storage device 32c to the load device 30d.

### Control Device 42

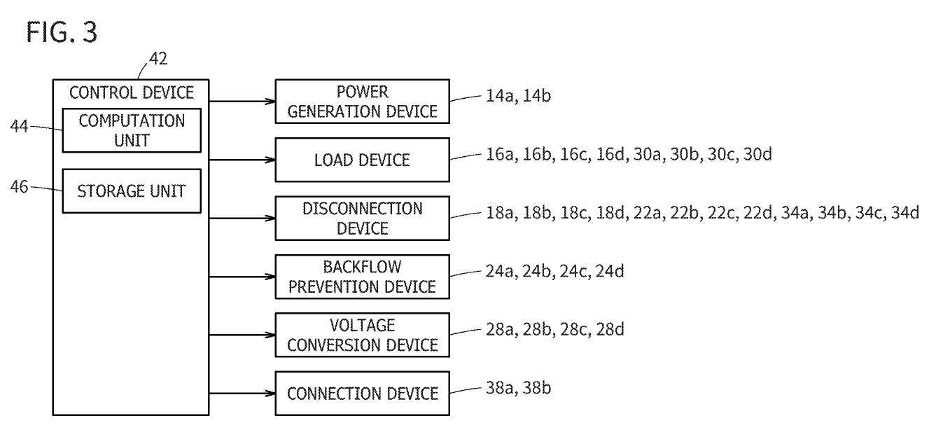

FIG. 3 is a control block diagram of the control device 42 according to the embodiment. The power supply system 10 includes the control device 42.

The control device 42 includes a computation unit 44 and a storage unit 46. The computation unit 44 is, for example, a processor such as a central processing unit (CPU) or a graphics processing unit (GPU). The computation unit 44 controls each device by executing a program stored in the storage unit 46. At least part of the computation unit 44 may be realized by an integrated circuit such as an application specific integrated circuit (ASIC) or a field-programmable gate array (FPGA). At least part of the computation unit 44 may be realized by an electronic circuit including a discrete device.

The storage unit 46 is constituted by a volatile memory (not shown) and a non-volatile memory (not shown) which are computer-readable storage media. The volatile memory is, for example, a random access memory (RAM) or the like. The non-volatile memory is, for example, a read only memory (ROM), a flash memory, or the like. Data and the like are stored in, for example, the volatile memory. Programs, tables, maps, and the like are stored in, for example, the non-volatile memory. At least part of the storage unit 46 may be included in the processor, the integrated circuit, or the like described above.

The control device 42 controls each of the power generation device 14a, the power generation device 14b, the load device 16a, the load device 16b, the load device 16c, the load device 16d, the disconnection device 18a, the disconnection device 18b, the disconnection device 18c, the disconnection device 18d, the disconnection device 22a, the disconnection device 22b, the disconnection device 22c, the disconnection device 22d, the backflow prevention device 24a, the backflow prevention device 24b, the backflow prevention device 24c, the backflow prevention device 24d, the voltage conversion device 28a, the voltage conversion device 28b, the voltage conversion device 28c, the voltage conversion device 28d, the load device 30a, the load device 30b, the load device 30c, the load device 30d, the disconnection device 34a, the disconnection device 34b, the disconnection device 34c, the disconnection device 34d, the connection device 38a, and the connection device 38b. Distributed control may be performed by a plurality of the control devices 42.

### 2-2. OPERATION OF POWER SUPPLY SYSTEM 10 IN NORMAL STATE

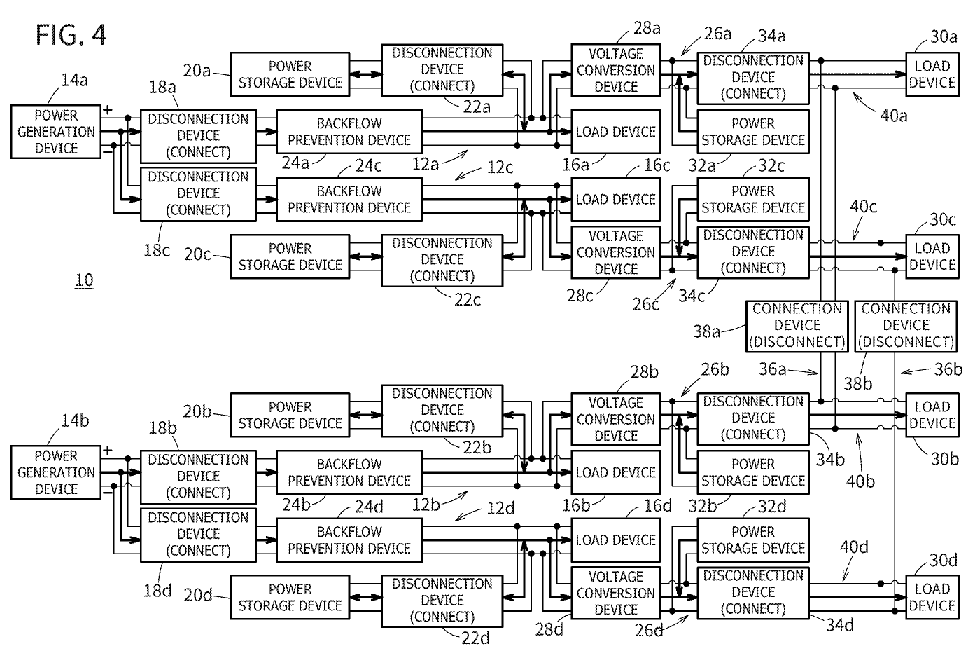

FIG. 4 is a diagram showing the operation of the power supply system 10 according to the embodiment in a normal state. Arrows shown in FIG. 4 indicate electric power supply paths. In a normal state, each of the disconnection devices is in a connecting state.

The power generation device 14a is connected to the power supply circuit 12a by the disconnection device 18a. Further, the power generation device 14a is connected to the power supply circuit 12c by the disconnection device 18c. As a result, electric power is supplied from the power generation device 14a to the load device 16a and the load device 16c.

The power generation device 14b is connected to the power supply circuit 12b by the disconnection device 18b. Further, the power generation device 14b is connected to the power supply circuit 12d by the disconnection device 18d. As a result, electric power is supplied from the power generation device 14b to the load device 16b and the load device 16d.

The power storage device 20a is connected to the power generation device 14a and the load device 16a by the disconnection device 22a. As a result, in the case where electric power supplied from the power generation device 14a to the load device 16a is insufficient, electric power can be supplied (discharged) from the power storage device 20a to the load device 16a. On the other hand, in the case where electric power supplied from the power generation device 14a to the load device 16a is excessive, the power storage device 20a can be supplied (charged) with electric power from the power generation device 14a. That is, the power storage device 20a has a power buffer function in the power supply circuit 12a.

In the same manner as the power storage device 20a, the power storage device 20c has a power buffer function in the power supply circuit 12c. Further, the power storage device 20b has a power buffer function in the power supply circuit 12b. Furthermore, the power storage device 20d has a power buffer function in the power supply circuit 12d.

The voltage conversion device 28a is connected to the load device 30a by the disconnection device 34a. In this state, the control device 42 performs step-down control in which DC power supplied from the power generation device 14a is stepped down by the voltage conversion device 28a and the stepped down DC power is supplied to the load device 30a. As a result, electric power is supplied from the power generation device 14a to the load device 30a. In the case where electric power supplied from the power generation device 14a to the load device 30a is insufficient, electric power is supplied from the power storage device 32a to the load device 30a.

The voltage conversion device 28c is connected to the load device 30c by the disconnection device 34c. In this state, the control device 42 performs step-down control in which DC power supplied from the power generation device 14a is stepped down by the voltage conversion device 28c and the stepped down DC power is supplied to the load device 30c. As a result, electric power is supplied from the power generation device 14a to the load device 30c. In the case where electric power supplied from the power generation device 14a to the load device 30c is insufficient, electric power is supplied from the power storage device 32c to the load device 30c.

The voltage conversion device 28b is connected to the load device 30b by the disconnection device 34b. In this state, the control device 42 performs step-down control in which DC power supplied from the power generation device 14b is stepped down by the voltage conversion device 28b and the stepped down DC power is supplied to the load device 30b. As a result, electric power is supplied from the power generation device 14b to the load device 30b. In the case where electric power supplied from the power generation device 14b to the load device 30b is insufficient, electric power is supplied from the power storage device 32b to the load device 30b.

The voltage conversion device 28d is connected to the load device 30d by the disconnection device 34d. In this state, the control device 42 performs step-down control in which DC power supplied from the power generation device 14b is stepped down by the voltage conversion device 28d and the stepped down DC power is supplied to the load device 30d. As a result, electric power is supplied from the power generation device 14b to the load device 30d. In the case where electric power supplied from the power generation device 14b to the load device 30d is insufficient, electric power is supplied from the power storage device 32d to the load device 30d.

### 2-3. Operation of Power Supply System 10 When Abnormality Occurs

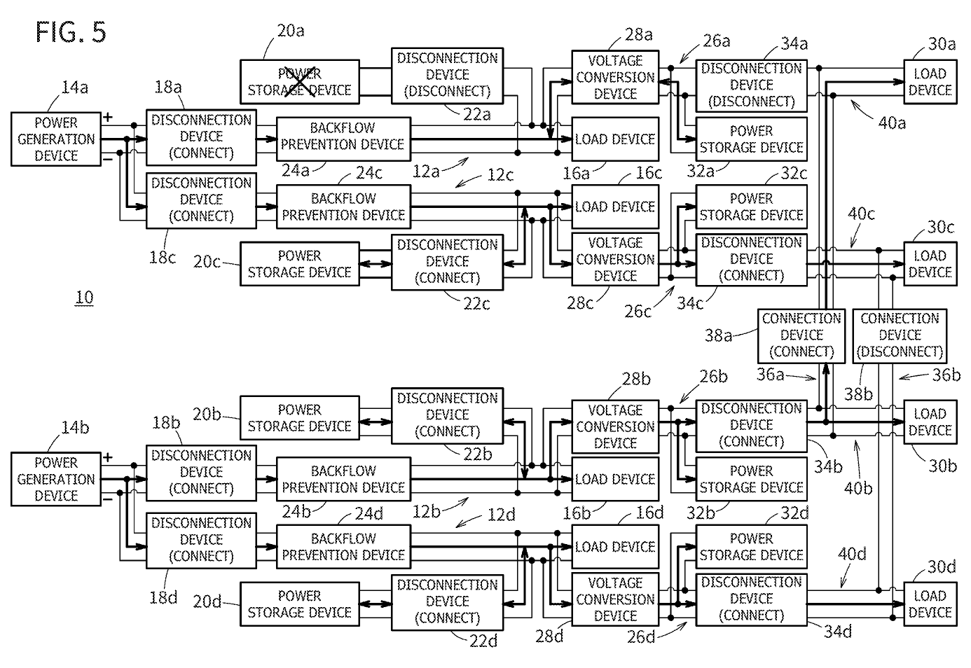

FIG. 5 is a diagram showing the operation of the power supply system 10 according to the embodiment in the event of an abnormality. Arrows shown in FIG. 5 indicate electric power supply paths.

For example, when an abnormality related to the power storage device 20a occurs, such as wire breaking (disconnection) or short-circuit of a wire between the power storage device 20a and the disconnection device 22a, or a failure of the power storage device 20a, the power storage device 20a becomes unusable. Then, the power buffer function in the power supply circuit 12a, which has been performed by the power storage device 20a, is lost. In the present disclosure, when an abnormality related to the power storage device 20a occurs, power buffering in the power supply circuit 12a is performed using the power storage device 32a instead of the power storage device 20a.

In the case where an abnormality related to the power storage device 20a is detected, the control device 42 switches the connection device 38a from the disconnecting state to the connecting state. Further, the control device 42 switches the disconnection device 34a from the connecting state to the disconnecting state. As a result, the load device 30a is disconnected from the voltage conversion device 28a (that is, the power generation device 14a and the power storage device 20a) and the power storage device 32a, and is connected, via the connection device 38a, to the voltage conversion device 28b (that is, the power generation device 14b and the power storage device 20b) and the power storage device 32b. In this manner, the electric power supply path to the load device 30a is switched. Thus, the supply of electric power to the load device 30a is maintained.

In the case of determining that electric power supplied from the power generation device 14a to the load device 16a is excessive, the control device 42 performs step-down control in which DC power supplied from the power generation device 14a is stepped down by the voltage conversion device 28a and the stepped down DC power is supplied to the power storage device 32a. In the case of performing the step-down control, the control device 42 controls the transformation ratio of the voltage conversion device 28a so that the voltage on the secondary side (the stepped down voltage) becomes higher than the voltage of the power storage device 32a. As a result, the DC power is supplied to the power storage device 32a, and the power storage device 32a is charged.

In the case of determining that electric power supplied from the power generation device 14a to the load device 16a is insufficient, the control device 42 performs boost control in which DC power supplied from the power storage device 32a is boosted by the voltage conversion device 28a and the boosted DC power is supplied to the power supply circuit 12a. In the case of performing the boost control, the control device 42 controls the transformation ratio of the voltage conversion device 28a so that the voltage on the primary side (the boosted voltage) becomes higher than the voltage of the power supply circuit 12a. As a result, the DC power is supplied from the power storage device 32a, and the power storage device 32a is discharged.

As described above, the power storage device 32a can perform power buffering in the power supply circuit 12a instead of the power storage device 20a. It should be noted that, in the power supply system 10, power buffering using each of the power storage device 32c, the power storage device 32b, and the power storage device 32d is also possible. That is, when an abnormality related to the power storage device 20c occurs, power buffering in the power supply circuit 12c may be performed using the power storage device 32c instead of the power storage device 20c. When an abnormality related to the power storage device 20b occurs, power buffering in the power supply circuit 12b may be performed using the power storage device 32b instead of the power storage device 20b. When an abnormality related to the power storage device 20d occurs, power buffering in the power supply circuit 12d may be performed using the power storage device 32d instead of the power storage device 20d.

### 3. Modification

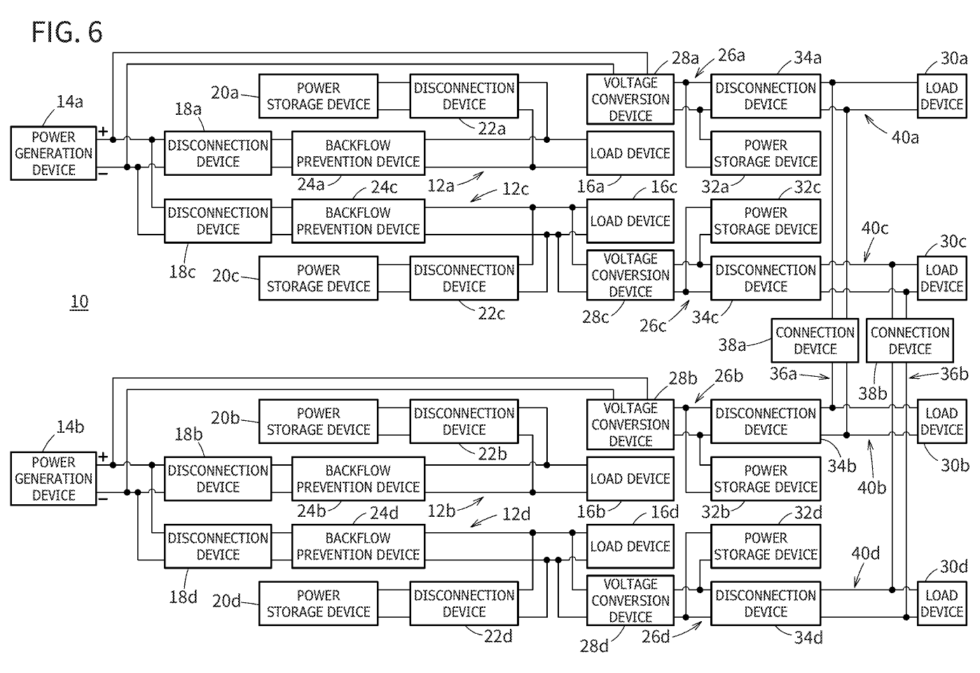

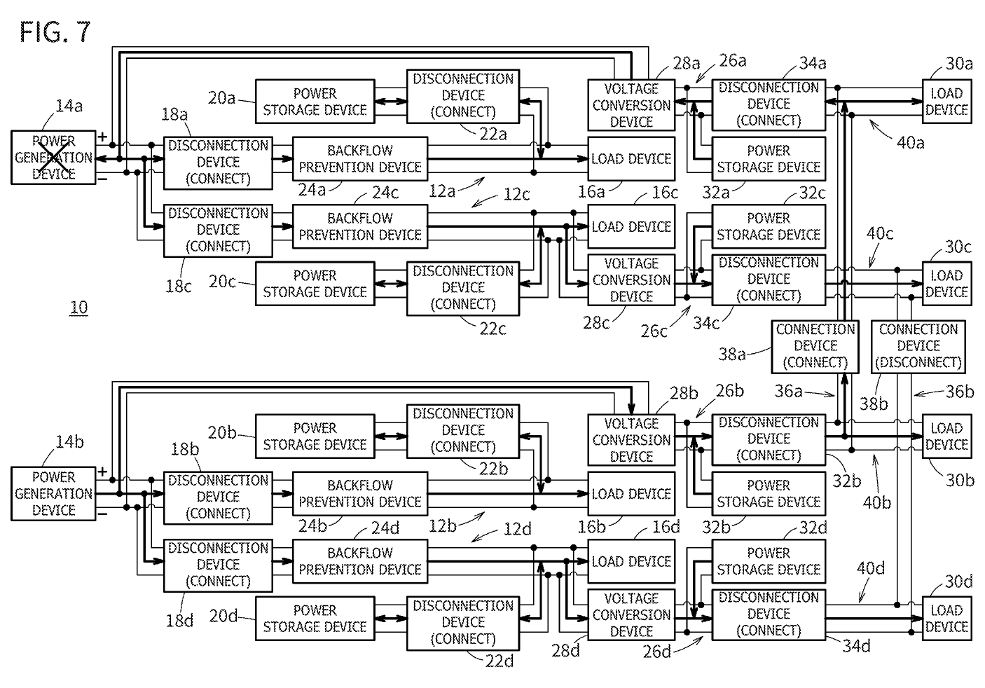

FIG. 6 is a schematic diagram of the power supply system 10 according to a modification. FIG. 7 is a diagram showing the operation of the power supply system 10 according to the modification at the time of restarting the generator. The arrows shown in FIG. 7 indicate electric power supply paths.

The low-voltage circuit 26a may be connected, via the voltage conversion device 28a, to a partial circuit between the power generation device 14a and the backflow prevention device 24a in the power supply circuit 12a. Similarly, the low-voltage circuit 26b may be connected, via the voltage conversion device 28b, to a partial circuit between the power generation device 14b and the backflow prevention device 24b in the power supply circuit 12b.

According to the modification shown in FIG. 6, the power generation device 14b and the power generation device 14a can be connected to each other while bypassing the backflow prevention device 24a and the backflow prevention device 24b. For example, as shown in FIG. 7, in the case where the power generation device 14a is stopped and the power generation device 14b is operating, DC power can be supplied from the power generation device 14b to the power generation device 14a via the low-voltage circuit 26b and the low-voltage circuit 26a. This makes it possible to start the generator of the power generation device 14a and restart the engine.

In this case, after switching the connection device 38a from the disconnecting state to the connecting state, the control device 42 performs the step-down control in the voltage conversion device 28b and performs the boost control in the voltage conversion device 28a.

In the embodiment shown in FIG. 4, in the case where the power generation device 14a is restarted using the power generation device 14b, it is necessary to control the transistor provided in the backflow prevention device 24a. On the other hand, in the modification shown in FIG. 6, in the case where the power generation device 14a is restarted using the power generation device 14b, it is not necessary to control the transistor provided in the backflow prevention device 24a.

### 4. Supplementary Notes

The following supplementary notes are further disclosed in relation to the above-described embodiment.

### Supplementary Note 1

The power supply system (10) of the present disclosure includes: the first power supply circuit (12a) configured to supply, to the first load device (16a), DC power output from the first power generation device (14a); the first power storage device (20a) connected to the first power supply circuit in parallel with the first power generation device; the second power storage device (32a) connected to the first power supply circuit in parallel with the first power generation device and having a rated output voltage lower than a rated output voltage of the first power storage device; the first voltage conversion device (28a) configured to step down DC power supplied from the first power generation device and supply the stepped down DC power to the second load device (30a) and the second power storage device, and configured to boost DC power supplied from the second power storage device and supply the boosted DC power to the first power supply circuit; and the first disconnection device (34a) configured to disconnect the second load device from the first voltage conversion device and the second power storage device.

According to the above configuration, the second power storage device can perform power buffering in the first power supply circuit instead of the first power storage device.

### Supplementary Note 2

The power supply system according to Supplementary Note 1 may further include the control device (42) configured to, in a state where the second load device is disconnected from the first voltage conversion device and the second power storage device by the first disconnection device, perform step-down control in which DC power supplied from the first power generation device is stepped down by the first voltage conversion device and the stepped down DC power is supplied to the second power storage device, and perform boost control in which DC power supplied from the second power storage device is boosted by the first voltage conversion device and the boosted DC power is supplied to the first power supply circuit.

### Supplementary Note 3

The power supply system according to Supplementary Note 1 may further include: the second power supply circuit (12b) configured to supply, to the third load device (16b), DC power output from the second power generation device (14b); the third power storage device (20b) connected to the second power supply circuit in parallel with the second power generation device; the fourth power storage device (32b) connected to the second power supply circuit in parallel with the second power generation device and having a rated output voltage lower than a rated output voltage of the third power storage device; the second voltage conversion device (28b) configured to step down DC power supplied from the second power generation device and supply the stepped down DC power to the fourth load device (30b) and the fourth power storage device, and configured to boost DC power supplied from the fourth power storage device and supply the boosted DC power to the second power supply circuit; the second disconnection device (34b) configured to disconnect the fourth load device from the second voltage conversion device and the fourth power storage device; and the first connection circuit (36a) provided with the first connection device (38a) configured to connect the circuit (40a) configured to supply DC power to the second load device and the circuit (40b) configured to supply DC power to the fourth load device.

According to the above configuration, the supply of electric power to the second load device is maintained.

### Supplementary Note 4

The power supply system according to Supplementary Note 3 may further include the control device configured to, in a state where the second load device is disconnected from the first voltage conversion device and the second power storage device by the first disconnection device, and the circuit configured to supply DC power to the second load device and the circuit configured to supply DC power to the fourth load device are connected by the first connection device, perform step-down control in which DC power supplied from the first power generation device is stepped down by the first voltage conversion device and the stepped down DC power is supplied to the second power storage device, and perform boost control in which DC power supplied from the second power storage device is boosted by the first voltage conversion device and the boosted DC power is supplied to the first power supply circuit.

### Supplementary Note 5

The power supply system according to Supplementary Note 3 may further include the control device configured to, in a state where the circuit configured to supply DC power to the second load device and the circuit configured to supply DC power to the fourth load device are connected by the first connection device, perform control to restart the first power generation device by supplying DC power from the second power generation device or the fourth power storage device to the first power generation device.

### Supplementary Note 6

The power supply system according to Supplementary Note 3 may further include: the third power supply circuit (12c) configured to supply, to the fifth load device (16c), DC power output from the first power generation device; the fifth power storage device (20c) connected to the third power supply circuit in parallel with the first power generation device; the sixth power storage device (32c) connected to the third power supply circuit in parallel with the first power generation device and having a rated output voltage lower than a rated output voltage of the fifth power storage device; the third voltage conversion device (28c) configured to step down DC power supplied from the first power generation device and supply the stepped down DC power to the sixth load device (30c) and the sixth power storage device, and configured to boost DC power supplied from the sixth power storage device and supply the boosted DC power to the third power supply circuit; the third disconnection device (34c) configured to disconnect the sixth load device from the third voltage conversion device and the sixth power storage device; the fourth power supply circuit (12d) configured to supply, to the seventh load device (16d), DC power output from the second power generation device; the seventh power storage device (20d) connected to the fourth power supply circuit in parallel with the second power generation device; the eighth power storage device (32d) connected to the fourth power supply circuit in parallel with the second power generation device and having a rated output voltage lower than a rated output voltage of the seventh power storage device; the fourth voltage conversion device (28d) configured to step down DC power supplied from the second power generation device and supply the stepped down DC power to the eighth load device (30d) and the eighth power storage device, and configured to boost DC power supplied from the eighth power storage device and supply the boosted DC power to the fourth power supply circuit; the fourth disconnection device (34d) configured to disconnect the eighth load device from the fourth voltage conversion device and the eighth power storage device; and the second connection circuit (36b) provided with the second connection device (38b) configured to connect the circuit (40c) configured to supply DC power to the sixth load device and the circuit (40d) configured to supply DC power to the eighth load device.

### Supplementary Note 7

The power supply system according to Supplementary Note 2 may further include: the third power supply circuit configured to supply, to the fifth load device, DC power output from the first power generation device; the fifth power storage device connected to the third power supply circuit in parallel with the first power generation device; the sixth power storage device connected to the third power supply circuit in parallel with the first power generation device and having a rated output voltage lower than a rated output voltage of the fifth power storage device; the third voltage conversion device configured to step down DC power supplied from the first power generation device and supply the stepped down DC power to the sixth load device and the sixth power storage device, and configured to boost DC power supplied from the sixth power storage device and supply the boosted DC power to the third power supply circuit; and the third disconnection device configured to disconnect the sixth load device from the third voltage conversion device and the sixth power storage device, wherein in the state where the second load device is disconnected from the first voltage conversion device and the second power storage device by the first disconnection device, the control device may perform the step-down control and the boost control and may connect the sixth load device to the third voltage conversion device and the sixth power storage device using the third disconnection device.

Although the present disclosure has been described in detail, the present disclosure is not limited to the above-described individual embodiments. Various additions, replacements, modifications, partial deletions, and the like can be made to these embodiments without departing from the essence and gist of the present disclosure, or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A power supply system comprising:
a first power supply circuit configured to supply, to a first load device, direct current electric power output from a first power generation device;
a first power storage device connected to the first power supply circuit in parallel with the first power generation device;
a second power storage device connected to the first power supply circuit in parallel with the first power generation device, the second power storage device having a rated output voltage lower than a rated output voltage of the first power storage device;
a first voltage conversion device configured to step down direct current electric power supplied from the first power generation device and supply the stepped down direct current electric power to a second load device and the second power storage device, and configured to boost direct current electric power supplied from the second power storage device and supply the boosted direct current electric power to the first power supply circuit; and
a first disconnection device configured to disconnect the second load device from the first voltage conversion device and the second power storage device.

2. The power supply system according to claim 1, further comprising one or more processors that execute computer-executable instructions stored in a memory, wherein
in a state where the second load device is disconnected from the first voltage conversion device and the second power storage device by the first disconnection device, the one or more processors execute the computer-executable instructions to cause the power supply system to perform step-down control in which direct current electric power supplied from the first power generation device is stepped down by the first voltage conversion device and the stepped down direct current electric power is supplied to the second power storage device, and perform boost control in which direct current electric power supplied from the second power storage device is boosted by the first voltage conversion device and the boosted direct current electric power is supplied to the first power supply circuit.

3. The power supply system according to claim 1, further comprising:
a second power supply circuit configured to supply, to a third load device, direct current electric power output from a second power generation device;
a third power storage device connected to the second power supply circuit in parallel with the second power generation device;
a fourth power storage device connected to the second power supply circuit in parallel with the second power generation device, the fourth power storage device having a rated output voltage lower than a rated output voltage of the third power storage device;
a second voltage conversion device configured to step down direct current electric power supplied from the second power generation device and supply the stepped down direct current electric power to a fourth load device and the fourth power storage device, and configured to boost direct current electric power supplied from the fourth power storage device and supply the boosted direct current electric power to the second power supply circuit;
a second disconnection device configured to disconnect the fourth load device from the second voltage conversion device and the fourth power storage device; and
a first connection circuit provided with a first connection device configured to connect a circuit configured to supply direct current electric power to the second load device and a circuit configured to supply direct current electric power to the fourth load device.

4. The power supply system according to claim 3, further comprising one or more processors that execute computer-executable instructions stored in a memory, wherein
in a state where the second load device is disconnected from the first voltage conversion device and the second power storage device by the first disconnection device, and the circuit configured to supply direct current electric power to the second load device and the circuit configured to supply direct current electric power to the fourth load device are connected by the first connection device, the one or more processors execute the computer-executable instructions to cause the power supply system to perform step-down control in which direct current electric power supplied from the first power generation device is stepped down by the first voltage conversion device and the stepped down direct current electric power is supplied to the second power storage device, and perform boost control in which direct current electric power supplied from the second power storage device is boosted by the first voltage conversion device and the boosted direct current electric power is supplied to the first power supply circuit.

5. The power supply system according to claim 3, further comprising one or more processors that execute computer-executable instructions stored in a memory, wherein
in a state where the circuit configured to supply direct current electric power to the second load device and the circuit configured to supply direct current electric power to the fourth load device are connected by the first connection device, the one or more processors execute the computer-executable instructions to cause the power supply system to perform control to restart the first power generation device by supplying direct current electric power from the second power generation device or the fourth power storage device to the first power generation device.

6. The power supply system according to claim 3, further comprising:
a third power supply circuit configured to supply, to a fifth load device, direct current electric power output from the first power generation device;
a fifth power storage device connected to the third power supply circuit in parallel with the first power generation device;
a sixth power storage device connected to the third power supply circuit in parallel with the first power generation device, the sixth power storage device having a rated output voltage lower than a rated output voltage of the fifth power storage device;
a third voltage conversion device configured to step down direct current electric power supplied from the first power generation device and supply the stepped down direct current electric power to a sixth load device and the sixth power storage device, and configured to boost direct current electric power supplied from the sixth power storage device and supply the boosted direct current electric power to the third power supply circuit;
a third disconnection device configured to disconnect the sixth load device from the third voltage conversion device and the sixth power storage device;
a fourth power supply circuit configured to supply, to a seventh load device, direct current electric power output from the second power generation device;
a seventh power storage device connected to the fourth power supply circuit in parallel with the second power generation device;
an eighth power storage device connected to the fourth power supply circuit in parallel with the second power generation device, the eighth power storage device having a rated output voltage lower than a rated output voltage of the seventh power storage device;
a fourth voltage conversion device configured to step down direct current electric power supplied from the second power generation device and supply the stepped down direct current electric power to an eighth load device and the eighth power storage device, and configured to boost direct current electric power supplied from the eighth power storage device and supply the boosted direct current electric power to the fourth power supply circuit;
a fourth disconnection device configured to disconnect the eighth load device from the fourth voltage conversion device and the eighth power storage device; and
a second connection circuit provided with a second connection device configured to connect a circuit configured to supply direct current electric power to the sixth load device and a circuit configured to supply direct current electric power to the eighth load device.

7. The power supply system according to claim 2, further comprising:
a third power supply circuit configured to supply, to a fifth load device, direct current electric power output from the first power generation device;
a fifth power storage device connected to the third power supply circuit in parallel with the first power generation device;
a sixth power storage device connected to the third power supply circuit in parallel with the first power generation device, the sixth power storage device having a rated output voltage lower than a rated output voltage of the fifth power storage device;
a third voltage conversion device configured to step down direct current electric power supplied from the first power generation device and supply the stepped down direct current electric power to a sixth load device and the sixth power storage device, and configured to boost direct current electric power supplied from the sixth power storage device and supply the boosted direct current electric power to the third power supply circuit; and
a third disconnection device configured to disconnect the sixth load device from the third voltage conversion device and the sixth power storage device, wherein
in the state where the second load device is disconnected from the first voltage conversion device and the second power storage device by the first disconnection device, the one or more processors cause the power supply system to perform the step-down control and the boost control, and to connect the sixth load device to the third voltage conversion device and the sixth power storage device using the third disconnection device.
